(19) United States
(12) Patent Application Publication
(10) Pub. No.: US 2007/0098281 A1
(43) Pub. Date: May 3, 2007

(54) Damping rotational vibration in a multi-drive tray

(75) Inventors: Yoshihiro Fujie, Kanagawa-ken (JP); Kenton C. Green, Cary, NC (US); Kenji Hidaka, Kanagawa-ken (JP); Gregg S. Lucas, Tucson, AZ (US); Michihiro Okamoto, Kanagawa-ken (JP); Kenneth R. Schneebeli, San Jose, CA (US); Tohru Sumiyoshi, Kanagawa-ken (JP); James S. Womble, Hillsborough, NC (US)

Correspondence Address: QUARLES & BRADY STREICH LANG LLP, 1 SOUTH CHURCH AVENUE, SUITE 1700, TUCSON, AZ, 85701, US

(73) Assignee: International Business Machines Corporation, Armonk, NY (US)

(21) Appl. No.: 11/263,363

(22) Filed: Oct. 31, 2005

(51) Int. Cl. G06K 9/36

(52) U.S. Cl. 382/239

(57) ABSTRACT

One or more layers of constrained layer damping material is strategically placed within a data storage library having one or more sources of rotational vibration energy. Data storage devices, such as disk drives, are isolated from each other and from a drive tray by a first layer of constrained layer damping material. The drive trays are isolated from drive enclosure bays by a second layer of constrained layer damping material. A third layer of constrained layer damping material isolates each drive enclosure bay from the housing of the data storage library. The net effect is a significant reduction of the amount of rotational vibration energy arriving at each data storage device from other system components, such as a blower module. Additionally, the amount of rotational vibration energy arriving at each data storage device from other data storage devices is also reduced. By mounting the data storage devices to the drive trays in a single plane, the rigidity and mass of the drive tray is increased, reducing its susceptibility to external rotational vibration energy.

### BACKGROUND OF THE INVENTION

1. Field of the Invention

This invention is related in general to the field of data management systems. In particular, the invention consists of a method for reducing rotational vibration in a multi-drive tray.

2. Description of the Prior Art

Data storage libraries are used for providing cost effective storage and retrieval of large quantities of data. In a data storage library, data is stored on data storage media that are, in turn, stored on storage shelves or on racks inside the library in a fashion that renders the media, and its resident data, accessible. Data storage media may comprise any type of media on which data may be stored, including but not limited to magnetic media (such as magnetic tape or disks), optical media (such as optical tap or disks), electronic media (such as PROM, EEPROM, flash PROM, Compactflash™, Smartmedia™ Memory Stick™, etc.), or other suitable media.

An exemplary data storage library may include a plurality of disparate components such as a power supply, a control module, an interconnect device, one or more communication devices, a blower module for removing heat, and one or more slots for receiving interchangeable components. These interchangeable components may include trays containing data storage devices and control components for managing the data storage devices.

Each tray may hold several data storage devices such as hard-disk drives, tape cartridges, optical-disk drives, or the like. These types of data storage devices traditionally operate by spinning a data storage media, such as a platter or disk, over a read/write head. The process of reading from or writing to the media may involve imparting energy to the disk to spin it up from a stopped or low velocity condition to a nominal operating speed. This spin up and subsequent operational rotation may impart significant vibration to the data storage device, its associated tray, and, by extension, the data storage library. Additionally, moving the read/write head radially over the disk may impart additional vibration to the system components. Another source of vibration may be the fan and motor of the blower, which may affect the operation of the data storage drives. These vibrations and associated noise can be bothersome to a system user. Additionally, this vibration may create fatigue on the mechanical structure of the system, may affect the performance of other system components, may result in faulty data being read from or written to the media, or may cause a component failure. Accordingly, it is desirable to have a method for reducing rotational vibration in a data storage system, including one that may have a plurality of data storage devices.

### SUMMARY OF THE INVENTION

The invention disclosed herein employs a damping design to minimize the transfer of vibration from a data storage library, specifically its blower which imparts significant vibrational energy, to its data storage drives. Another aspect of the invention is the reduction of vibration generated by the data storage devices themselves.

Constrained layer damping is applied to surfaces which come in contact with the data storage library housing, such as enclosures containing trays of data storage devices. Constrained layer damping may also be applied to the enclosures at the point of contact with the drive trays. Yet additional constrained layer damping is applied to the drive trays. Data storage drives are rigidly mounted on a single plane of each drive tray, providing enhanced rigidity in the critical rotational vibration axis and increasing the effective mass of their associated drive trays.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is an exploded view illustrating a data storage library including a housing, a blower module, and a plurality of data storage device enclosures, according to the invention.

FIG. 2 is a rear view of the data storage library of FIG. 1, more fully illustrating some of its major components.

FIG. 3 is an isometric view of a drive enclosure bay including drive trays containing data storage devices, according to the invention.

FIG. 4 is an exploded view of an exemplary constrained layer damping material, according to the invention.

FIG. 5 is an isometric view of the chassis of the drive enclosure bay of FIG. 3.

FIG. 6 is exploded view of the drive enclosure bay of FIG. 4, including constrained layer damping, according to the invention.

FIG. 7 is an isometric view of the drive tray of FIG. 3, including constrained layer damping, according to the invention.

FIG. 8 is an exploded view illustrating a data storage library similar to that of FIG. 1, including a first set of springs.

FIG. 9 is an isometric view of the drive tray of similar to that of FIG. 7, including a second set of springs.

### DESCRIPTION OF THE PREFERRED EMBODIMENTS

This invention is based on the idea of using constrained layer damping material applied to surfaces which come in contact with the data storage library housing, such as enclosures containing trays of data storage devices. The constrained layer damping material may also be applied to the enclosures at the point of contact with the drive trays. Yet additional constrained layer damping material is applied to the drive trays. Data storage drives are rigidly mounted on a single plane of each drive tray, providing enhanced rigidity in the critical rotational vibration axis and increasing the effective mass of their associated drive trays.

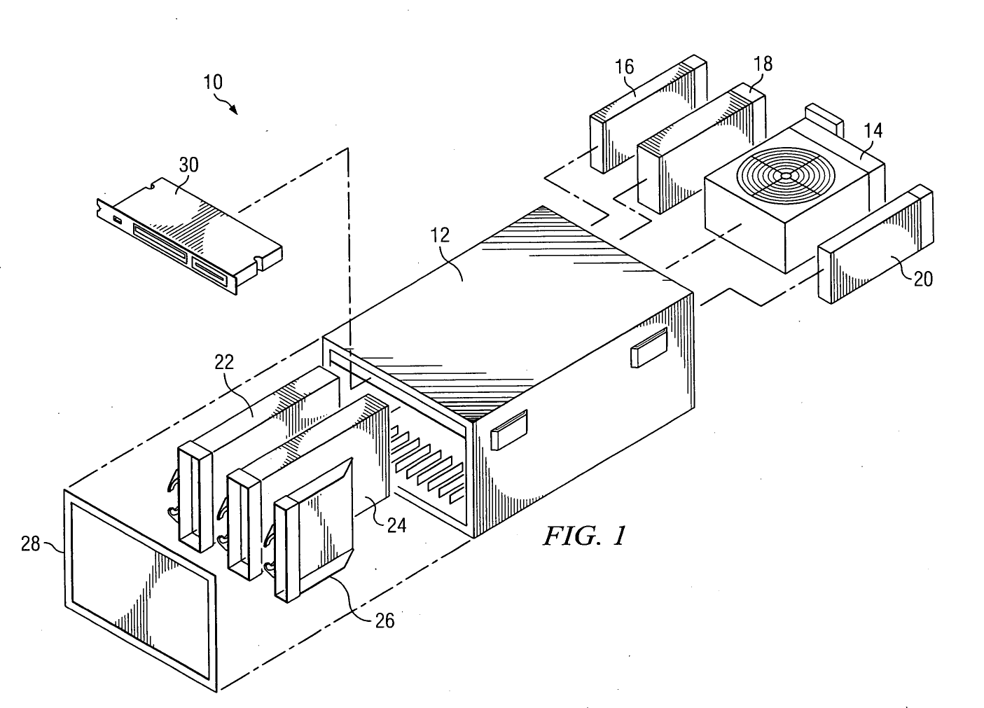

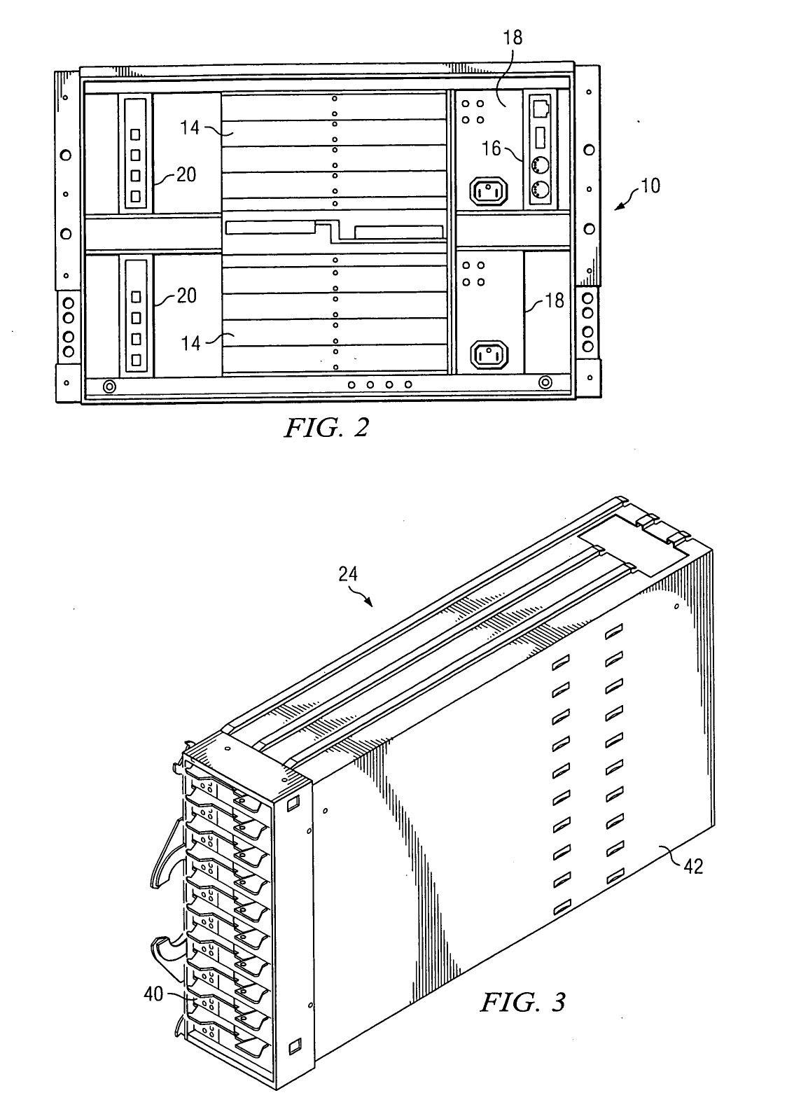

Referring to figures, wherein like parts are designated with the same reference numerals and symbols, FIG. 1 is an exploded view illustrating a data storage library 10 including a housing 12, a blower module 14, a management module 16, a power module 18, a switch module 20, a blade server 22, a drive enclosure bay 24, a filler blade 26, a front bezel 28, and a media tray 30 containing a CD-ROM drive, a USB port, and a diskette drive. FIG. 2 is a rear view of the data storage library 10 of FIG. 1, more fully illustrating the arrangement of the switch modules 20, the blower modules 14, the power modules 18, and the management module 16.

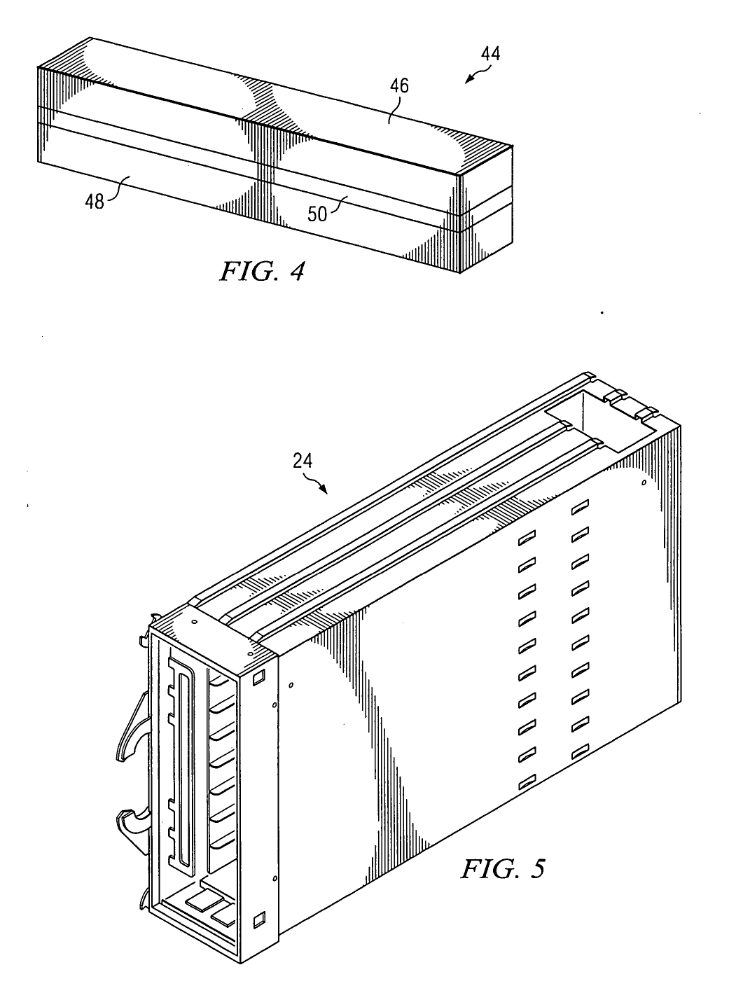

FIG. 3 is an isometric view of the drive enclosure bay 24 introduced in FIG. 1, including drive trays 40 containing data storage devices. A first layer 42 of constrained layer damping material is applied to the vertical surfaces of the drive enclosure bay 24, according to the invention. This layer 42 of constrained layer damping material reduces the amount of energy transferred to the drive enclosure bay 24 from the rotational vibration generated by the blower module 14. An exemplary constrained layer damping material 44 is illustrated in FIG. 4, wherein a first layer of metal 46 approximately 0.5 mm thick is connected to a second layer of metal 48 approximately 0.5 mm thick by a thin layer of adhesive 50.

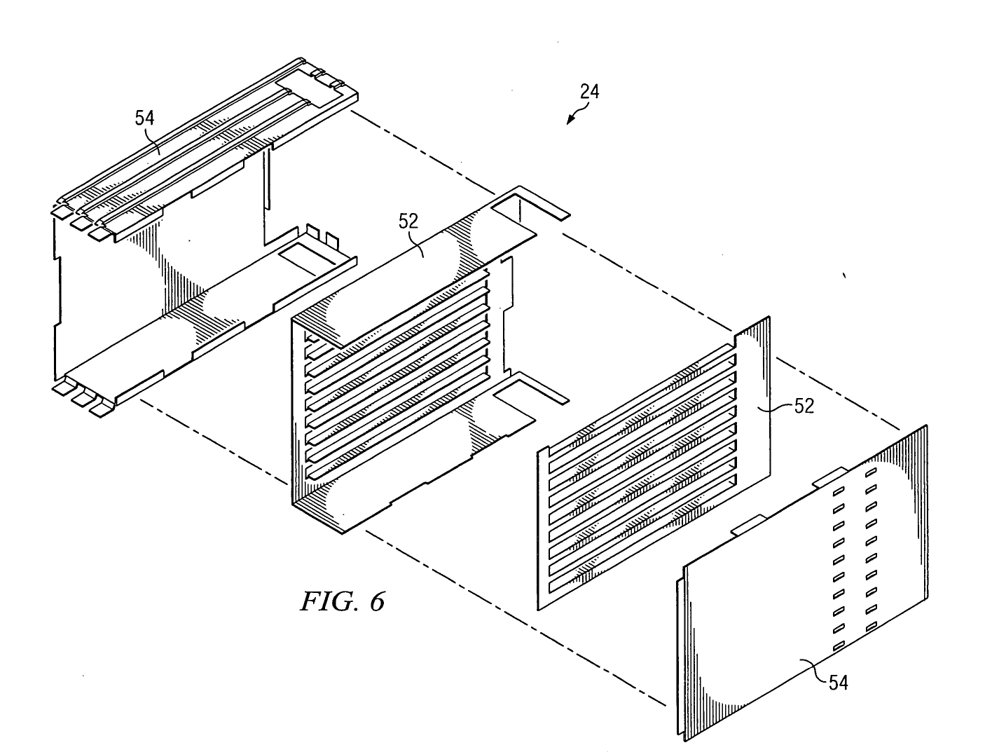

The isometric view of FIG. 5 illustrates the drive enclosure bay 24 of FIG. 3. FIG. 6 is exploded view of the drive enclosure bay 24, including constrained layer damping, according to the invention. Here, a layer of constrained layer material 52 is applied to the shell 54 of the drive enclosure bay 24. This layer 52 of constrained layer material reduces the energy transferred to each drive tray (not shown) generated by the blower module 14. Additionally, this layer 52 of constrained layer material reduces rotational vibration generated by other data storage devices located on other drive trays.

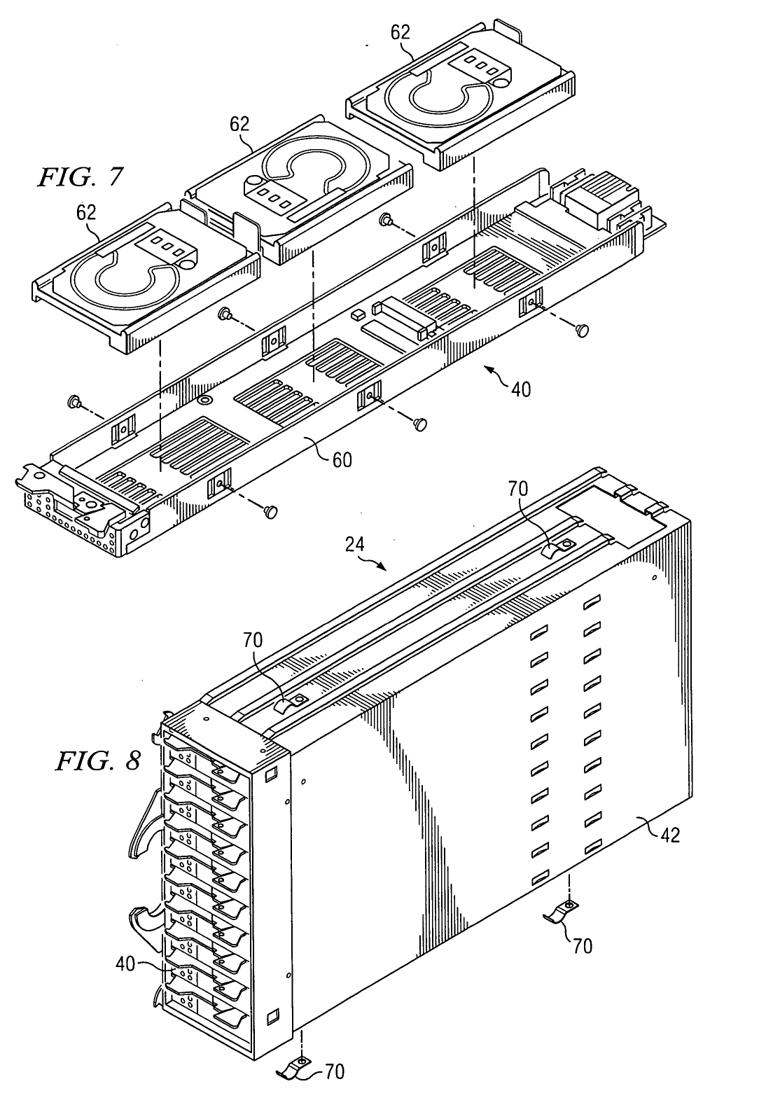

Yet another layer of constrained layer damping material 60 is applied to a drive tray 40 as illustrated in the isometric view of FIG. 7. Here, this layer 60 of constrained damping material reduces the amount of vibrational energy produced by the blower module 14 that reaches each data storage device 62. Additionally, this layer 60 reduces the amount of rotational vibration energy transmitted by each data storage device 62 to the drive tray 40 and, subsequently, other data storage devices.

The effect of the first, second, and third layers of constrained layer damping material is that the amount of rotational vibration energy reaching each data storage device from the blower module 14 is dramatically reduced. Additionally, the amount of rotational vibration energy reaching each data storage device from other data storage devices is also reduced.

Another aspect of the invention involves mounting each data storage device 62 that is associated with a particular drive tray 40 so that they are mounted in a single plane, as illustrated in FIG. 7. In so doing, the housing of each data storage device 62 may contribute to the rigidity of the drive tray 40 and increase the mass of the combination of components so as to reduce these components' susceptibility to rotational vibration.

FIG. 8 is an exploded view illustrating a data storage library similar to that of FIG. 1, including a first set of leaf springs 70. The springs 70, in combination with the layer of constrained layer damping material 42 (FIG. 3), reduce the amount of rotational vibration energy transmitted to the drive enclosure bay 24 from the housing 12. While leaf springs are illustrated for exemplary purposes, other types of springs may also be used.

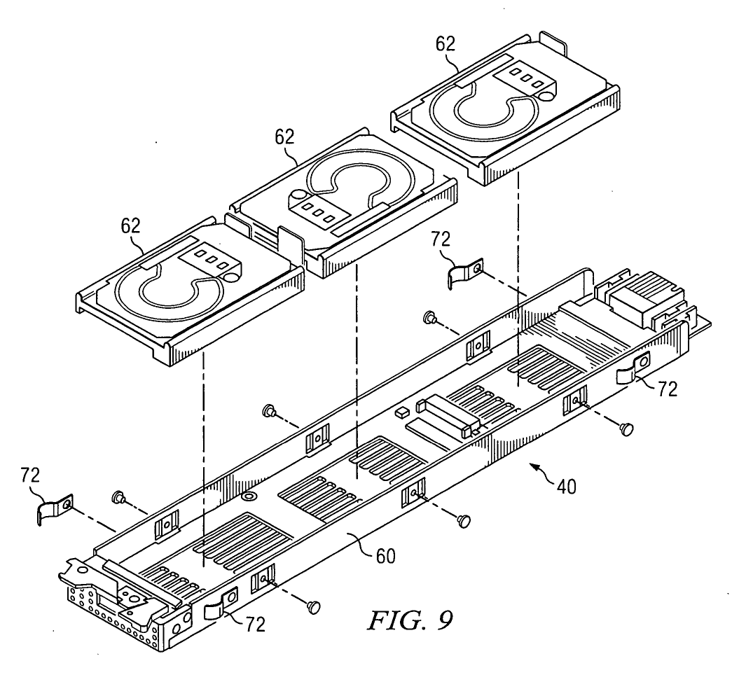

Another set of leaf springs 72 is illustrated in the isometric view of a drive tray 40 in FIG. 9. The springs 72, in combination with the layer of constrained layer damping material 60, reduce the amount of rotational vibration energy transmitted to the drive tray 40 from the drive enclosure bay 24.

Those skilled in the art of making data storage systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A data storage library, comprising:
a first rotational vibration energy source producing a first amount of rotational vibration energy;
a drive enclosure bay adapted to hold a drive tray, said drive tray including a first data storage device; and
a housing for holding the first rotational vibration energy source and for holding the drive enclosure bay, wherein the housing includes a first layer of constrained damping material adapted to reduce the first amount of rotational vibration energy that is transmitted to the drive enclosure bay by the housing.

2. The data storage library of claim 1, wherein the first rotational vibration energy source is a blower.

3. The data storage library of claim 1, wherein the first data storage device is a disk drive.

4. The data storage library of claim 1, further comprising a first set of springs connecting the drive enclosure bay to the housing.

5. The data storage library of claim 1, further comprising a second layer of constrained layer damping material placed between the drive enclosure bay and the drive tray and wherein the second layer of constrained damping material is adapted to reduce the first amount of rotational vibration energy that is transmitted to the drive tray by the drive enclosure bay.

6. The data storage library of claim 1, further comprising a second set of springs connecting the drive tray to the drive enclosure bay.

7. The data storage library of claim 5, further comprising a third layer of constrained layer damping material placed between the drive tray and the first data storage device, wherein the third layer of constrained layer damping material is adapted to reduce the first amount of rotational vibration energy that is transmitted to the first data storage device by the drive tray.

8. The data storage library of claim 1, comprising a second data storage device wherein the first data storage device and the second data storage device are mounted to the drive tray in a single plane.

9. A drive enclosure bay, comprising
a first rotational vibration energy source producing a first amount of rotational vibration energy;
a drive tray in communication with said first rotational vibration energy source, said drive tray including a first data storage device; and
a first layer of constrained layer damping material placed between the first rotational vibration energy source and the drive tray, wherein said first layer of constrained layer damping material is adapted to reduce the first amount of rotational vibration energy that is transmitted to the drive tray by the first rotational vibration energy source.

10. The drive enclosure bay of claim 9, further comprising a second layer of constrained layer damping material placed between the drive tray and the first data storage device and wherein the second layer of constrained damping material is adapted to reduce the first amount of rotational vibration energy that is transmitted to the first data storage device by the drive tray.

11. The data storage library of claim 9, comprising a second data storage device wherein the first data storage device and the second data storage device are mounted to the drive tray in a single plane.

12. The data storage library of claim 9, further comprising a second set of springs connecting the drive tray to the drive enclosure bay.

13. A drive tray, comprising
a first rotational vibration energy source producing a first amount of rotational vibration energy;
a first data storage device; and
a first layer of constrained layer damping material placed between said first data storage device and said first rotational vibration energy source, wherein the first layer of constrained layer damping material is adapted to reduce the first amount of rotational vibration energy that is transmitted to the first data storage device by the first rotational vibration energy source.

14. The drive tray of claim 13, further comprising a second data storage device, wherein the first data storage device and the second data storage device are mounted to the drive tray in a single plane.

15. The drive tray of claim 13, further comprising a second data storage device producing a second amount of rotational vibration energy, and wherein the first layer of constrained layer damping material is further adapted to reduce the second amount of rotational vibration energy that is transmitted to the first data storage device by the second data storage device.
